(19) United States
(12) Patent Application Publication
(10) Pub. No.: US 2019/0360514 A1
(43) Pub. Date: Nov. 28, 2019

(54) TUBE JOINT STRUCTURE FOR INDUSTRIAL-STYLE FURNITURE RACK

(71) Applicants: KUN LUNG CHENG, CHANGHUA COUNTY (TW); MIN LIANG CHANG, CHANGHUA COUNTY (TW)

(72) Inventors: KUN LUNG CHENG, CHANGHUA COUNTY (TW); MIN LIANG CHANG, CHANGHUA COUNTY (TW)

(21) Appl. No.: 16/239,872

(22) Filed: Jan. 4, 2019

(30) Foreign Application Priority Data
May 23, 2018 (TW) 107206738

(51) Int. Cl. F16B 12/40; F16B 7/04

(52) U.S. Cl. CPC F16B 12/40; F16B 7/0413; F16B 7/044

(57) ABSTRACT

A tube joint structure for industrial-style furniture rack includes a tube body. The tube body is assembled by two or more half-configured housings including a first housing and a second housing. The first housing and the second housing are respectively formed by stamping two metal pieces. Two recessed portions are formed on opposite sides of the first housing and the second housing, respectively. The recessed portion of the first housing and the recessed portion of the second housing enclose an accommodating space. The tube body has at least two tube openings communicating with the accommodating space.

### BACKGROUND OF THE INVENTION

### Field of the Invention

The present invention relates to components of industrial-style furniture racks, in particular to a tube joint structure for industrial-style furniture rack.

### Description of the Prior Art

In choosing furniture, users not only consider usefulness of the furniture, but also styles of the furniture. In general, the design styles of the furniture products can be formed by changes to the material, the color, and/ or the texture of the furniture products. Design styles mainly include the classical style, the natural style, the future style, the industrial style, etc. The industrial-style furniture products mainly have metal tubes, tube joints, and flange plates to perform the style as if the user stays in an industrial environment.

However, in manufacturing conventional industrial-style furniture products, the tube joints of the furniture products are conventional products. The conventional tube joints are integrally manufactured by green sand mold techniques, namely, the sand casting. When the tube joints manufactured by sand casting techniques are directly applied to the furniture racks, following problems occur.

First, manufacturing the conventional tube joints by sand casting is time-consuming and needs higher cost.

Second, the quality of the material for manufacturing the tube joints by sand casting and the casting procedures cannot be controlled easily, thus the tube joint product may have excessive impurities and toxic heavy metal ingredients.

Third, the conventional sand-casting tube joint has poor precision and prone to have uneven thicknesses. Furthermore, unwanted shrinkage porosities may be easily formed on the wall of the tube joint to affect the roundness of the tube opening of the tube joint greatly. As a result, the tube joint cannot be assembled with other components in a convenient manner.

Fourth, the conventional sand-casting tube joint is usually made of pig iron. As a result, the conventional sand-casting tube joint has surfaces with rough and porous features. Furthermore, free graphite left on the surface of the pig iron causes the difficulty for coloring the tube joint by electroplating.

Fifth, for manufacturing the tube racks used in the conventional industrial-style furniture products, the tube joint is fitted over the tube component, and then a soldering procedure is applied to fix the tube component with the tube joint. However, when the tube joint made of pig iron is to be fixed with the tube components made of other materials (e.g., stainless steel, aluminum, and copper) by soldering, the soldering cannot be achieved easily due to different material properties and the cost for soldering is thus very high.

### SUMMARY OF THE INVENTION

One object of the present invention is to provide a tube joint structure for industrial-style furniture rack, wherein the tube joint structure can be manufactured in a fast and cheap manner.

Another object of the present invention is to provide a tube joint structure for industrial-style furniture rack, wherein the product can prevent from having excessive impurities and toxic heavy metal ingredients as possibly occurred in the conventional sand-casting product.

Another object of the present invention is to provide a tube joint structure for industrial-style furniture rack, wherein the tube joint structure has a high precision, so that the assembly between the tube joint structure and the furniture tube component can be performed easily and quickly.

Another object of the present invention is to provide a tube joint structure for industrial-style furniture rack, wherein the material for making the tube joint structure is the same as the material for making the furniture tube component, the soldering between the tube joint structure and the furniture tube component can be performed easily, thereby effectively reducing the soldering cost.

Another object of the present invention is to provide a tube joint structure for industrial-style furniture rack, wherein the tube joint structure and the furniture tube component can be made of the same materials, so that the tube joint structure and the furniture tube component can be electroplated and colored after the tube joint structure and the furniture tube component are assembled with each other.

In view of these, a tube joint structure for industrial-style furniture rack is provided. In one embodiment, the tube joint structure comprises a tube body. The tube body is assembled by at least two half-configured housings comprising a first housing and a second housing. The first housing and the second housing are respectively formed by stamping two metal pieces. Two recessed portions are formed on opposite sides of the first housing and the second housing, respectively. The recessed portion of the first housing and the recessed portion of the second housing enclose an accommodating space. The tube body has at least two tube openings communicating with the accommodating space.

### BRIEF DESCRIPTION OF THE DRAWINGS

FIG. 1 illustrates a structural schematic view of a tube joint structure for industrial-style furniture rack according to an embodiment of the present invention;

FIG. 2 illustrates an assembled view of the tube joint structure;

FIG. 3 illustrates a structural schematic view showing that the tube joint structure is an arc-shaped structure;

FIG. 4 illustrates a structural schematic view showing that the tube joint structure is a T-shaped structure;

FIG. 5 illustrates a structural schematic view showing that the tube joint structure is a four-way tube structure;

FIG. 6 illustrates a structural schematic view showing that the tube joint structure forms a wall rack;

FIG. 7 illustrates a structural schematic view showing that the tube joint structure forms a stand rack; and

FIG. 8 illustrates a structural schematic view of a tube joint structure according to another embodiment of the present invention.

### DETAIL DESCRIPTION OF THE PREFERRED EMBODIMENTS

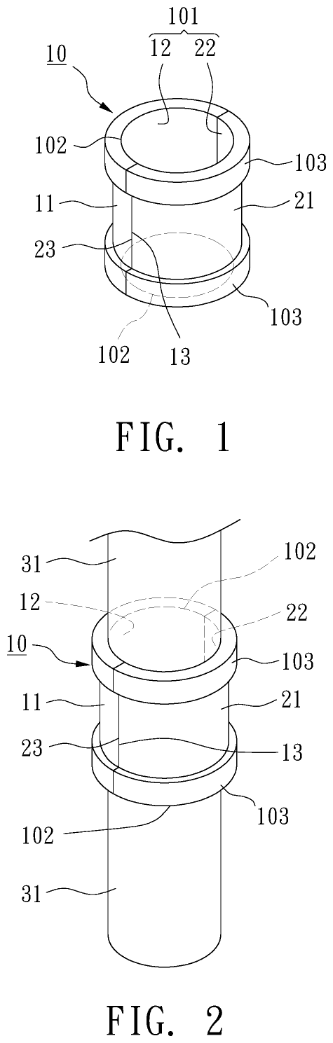

Please refer to FIGS. 1 and 2, illustrating a tube joint structure for industrial-style furniture rack according to an embodiment of the present invention. The tube joint structure is used for assembling with furniture tube components and is different from the tubes for passing fluids. Therefore, the seal tightness and leak proof properties are not taken into consideration. In this embodiment, the tube joint structure comprises a tube body 10. The tube body 10 is assembled by at least two half-configured housings comprising a first housing 11 and a second housing 21. The first housing 11 and the second housing 21 are respectively formed by stamping two metal pieces. The metal pieces may be, but not limited to, made of stainless steel, aluminum, copper, etc. The first housing 11 and the second housing 21 each are formed to have a half-circle piece, so that two recessed portions 12, 22 are respectively formed on opposite sides of the first housing 11 and the second housing 21. The recessed portion 12 of the first housing 11 and the recessed portion 22 of the second housing 21 enclose an accommodating space 101 at the inner portion of the tube body 10 for accommodating one or more furniture tube components. In this embodiment, the opposite sides of the first housing 11 and the second housing 21 respectively comprise two side surfaces 13, 23. The side surface 13 of the first housing 11 and the side surface 23 of the second housing 21 are flat surfaces aligned with each other. The side surface 13 of the first housing 11 and the side surface 23 of the second housing 21 are attached to each other, and then the first housing 11 and the second housing 21 are fixed with each other by a fixing means such as soldering, pin-locking, threading, gluing, or other fixing techniques. The fixing means allows a connection portion between the side surface 13 of the first housing 11 and the side surface 23 of the second housing 21 to form a linear fixing portion (e.g., a soldering line) or allows the connection portion between the side surface 13 of the first housing 11 and the side surface 23 of the second housing 21 to form a plurality of spaced fixing portions (e.g., soldering spots), so that the first housing 11 and the second housing 21 can be attached with each other to form an I-shaped structure. Moreover, the tube body 10 has two tube openings 102 facing different directions and communicating with the accommodating space 101. The two tube openings 102 can be inserted by end portions of a furniture tube component 31, and the recessed portion 12 of the first housing 11 and the recessed portion 22 of the second housing 21 can be fitted on the outer periphery of the furniture tube component 31. Moreover, for emphasizing the industrial rough style of the product, a protruding flange 103 may be formed on an outer periphery of each of the tube openings 102 during the stamping procedure. According to the foregoing descriptions, the tube joint structure according to one or some embodiments of the present invention can be manufactured.

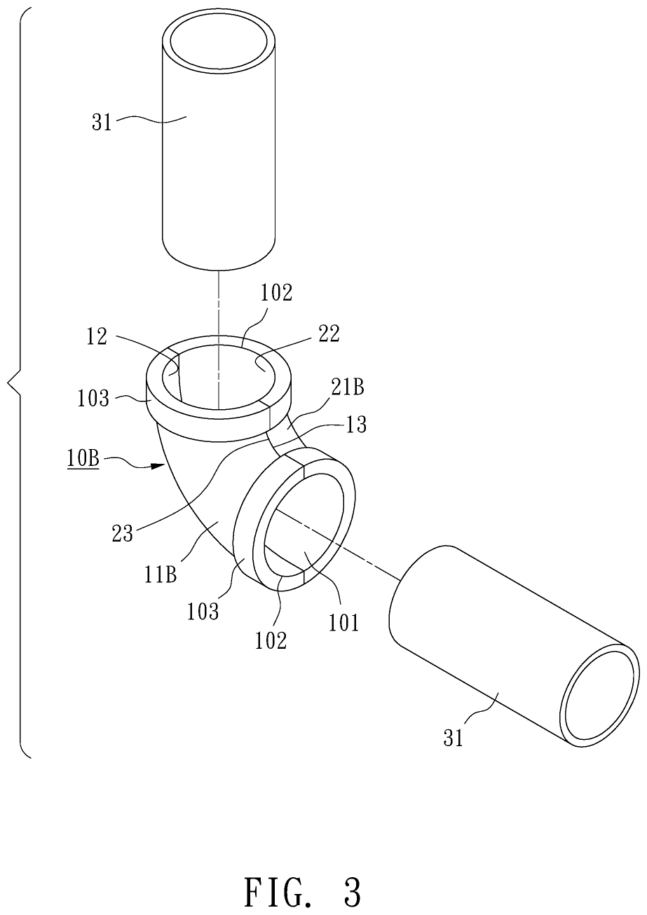

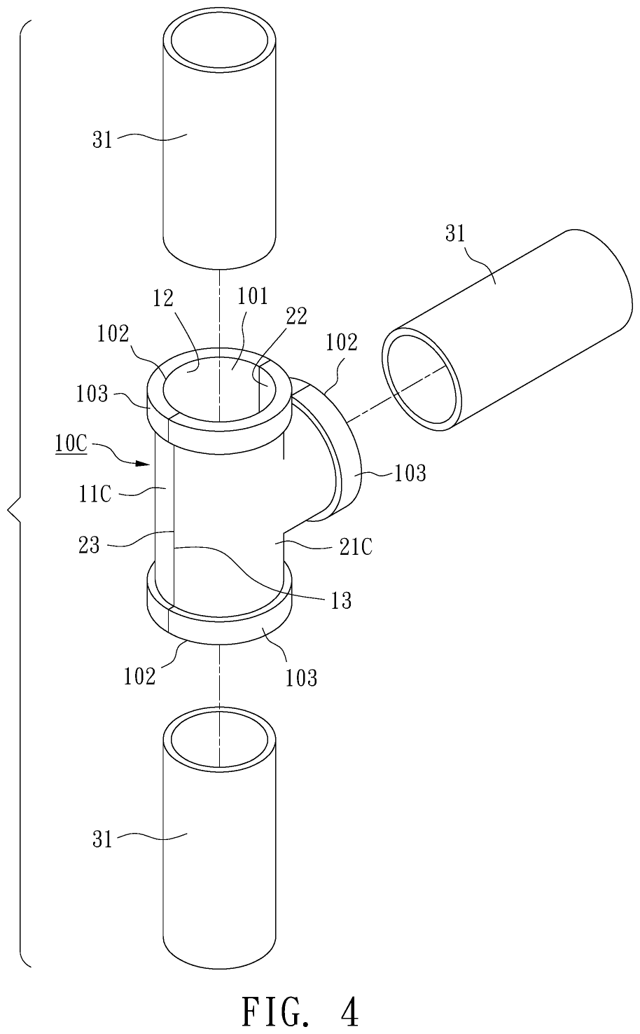

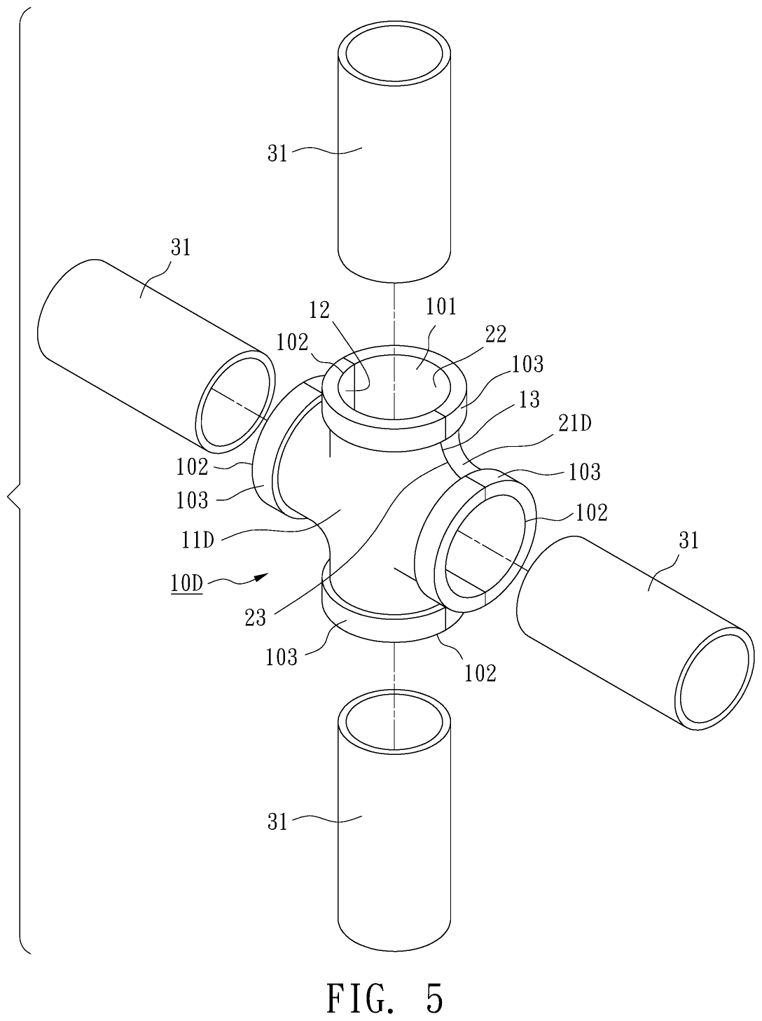

Besides the aforementioned I-shaped structure, the shape of the tube body 10 may be an arc-shaped structure, a T-shaped structure, a four-way tube structure, a five-way tube structure, or other common shapes for tube joints. Specifically, as shown in FIGS. 1 and 2, the tube body 10 is an I-shaped structure formed by assembling the first housing 11 with the second housing 21; as shown in FIG. 3, the tube body 10B is an arc-shaped structure formed by assembling the first housing 11B with the second housing 21B; as shown in FIG. 4, the tube body 10C is T-shaped structure formed by assembling the first housing 11C with the second housing 21C; and as shown in FIG. 5, the tube body 10D is a four-way tube structure formed by assembling the first housing 11D with the second housing 21D.

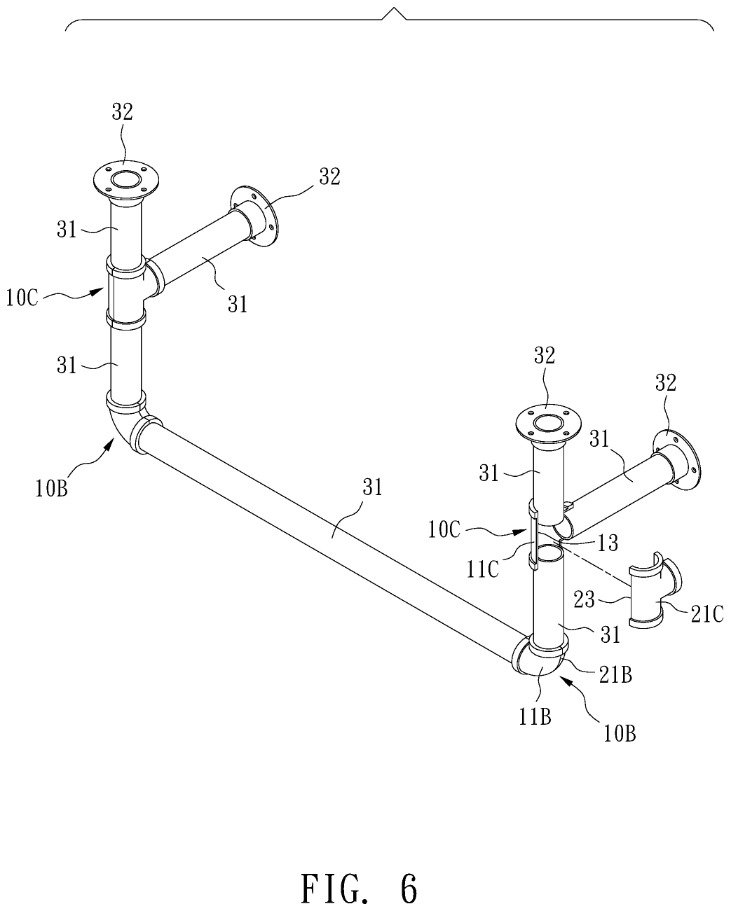

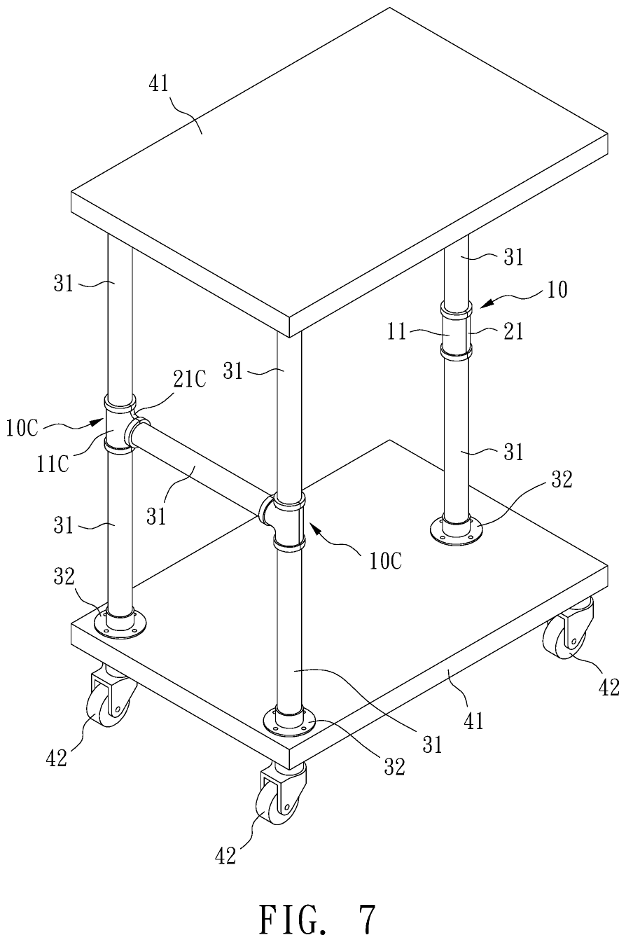

Accordingly, industrial-style furniture rack structures in different forms can be assembled according to user requirements. As shown in FIG. 6, by using the tube body 10C in T-shaped and the tube body 10B in arc-shaped as well as several furniture tube components 31 and flange plates 32, a wall rack can be assembled. Alternatively, as shown in FIG. 7, by using the tube body 10C in T-shaped and the tube body 10 in I-shaped as well as several furniture tube components 31, flange plates 32, boards 41, and wheels 42, a stand rack can be assembled. It is understood that, the tube joint structure according to one or some embodiments of the present invention may be assembled as a stand rack, a clothes stand, a lamp stand, an object rack, a decorative rack, a newspaper rack in different shapes and having industrial-style design features.

The tube joint structure according to one or some embodiments of the present invention has following advantages.

First, the first housing 11 and the second housing 21 are manufactured by stamping metal pieces, and then the first housing 11 and the second housing 21 are attached with each other to form the tube joint structure. Therefore, the tube joint structure can be manufactured in a fast and cheap manner.

Second, the tube joint structure is formed by stamping metal pieces. Therefore, the quality of the metal pieces can be controlled effectively to ensure low defect-free rate of the product. Moreover, the product can prevent from having excessive impurities and toxic heavy metal ingredients as possibly occurred in the conventional sand-casting product.

Third, the first housing 11 and the second housing 21 are respectively formed by stamping two metal pieces. Therefore, the tube joint structure has a high precision. After the first housing 11 is attached to the second housing 21, the tube opening 102 has a good roundness, and the assembly between the tube joint structure and the furniture tube component 31 can be performed easily and quickly.

Fourth, as mentioned, the tube joint structure are formed by stamping metal pieces, and the material of the metal pieces for stamping can be the same as the materials for making the furniture tube component 31 (e.g., the materials may be stainless steel, aluminum, or copper). Therefore, since the material for making the tube body 10 is the same as the material for making the furniture tube component 31, the soldering between the tube body 10 and the furniture tube component 31 can be performed easily, thereby effectively reducing the soldering cost.

Fifth, since the tube body 10 of the tube joint structure formed by metal pieces and the furniture tube component 31 can be made of the same materials, the tube body 10 and the furniture tube component 31 can be electroplated and colored after the tube body 10 and the furniture tube component 31 are assembled with each other.

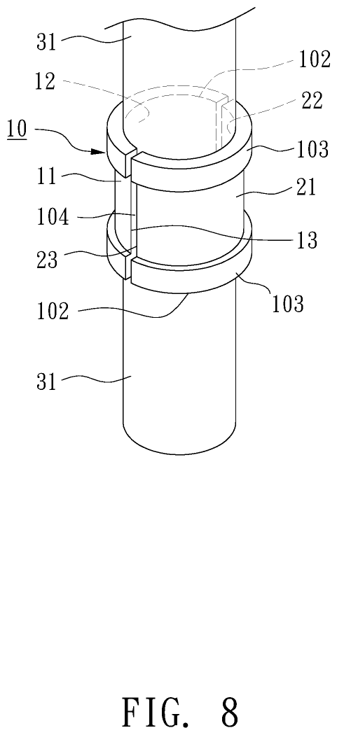

Furthermore, as shown in FIG. 8, a tube joint structure for industrial-style furniture rack according to a second embodiment of the present invention is illustrated. Mainly differences between the first embodiment and the second embodiment are described in the following paragraphs.

In this embodiment, the opposite sides of the first housing 11 and the second housing 21 comprise two side surfaces 13, 23, respectively. The side surface 13 of the first housing 11 and the side surface 23 of the second housing 21 are parallel aligned and spaced apart from each other, and a gap 104 is thus defined between the side surface 13 of the first housing 11 and the side surface 23 of the second housing 21. The recessed portion 12 of the first housing 11 and the recessed portion 22 of the second housing 21 are assembled on the outer periphery of a furniture tube component 31, and the first housing 11 and the second housing 21 are together fixed on the outer periphery of the furniture tube component 18 by a fixing means such as soldering, pin-locking, threading, gluing, or other fixing techniques. The fixing means allows a connection portion between the side surface 13 of the first housing 11 and the side surface 23 of the second housing 21 to form a linear fixing portion (e.g., a soldering line) or allows the connection portion between the side surface 13 of the first housing 11 and the side surface 23 of the second housing 21 to form a plurality of spaced fixing portions (e.g., soldering spots). Accordingly, industrial-style furniture rack structures in different forms can be manufactured. This embodiment also solves the problems occurred to the conventional product.

What is claimed is:

1. A tube joint structure for industrial-style furniture rack, comprising:
a tube body assembled by at least two half-configured housings comprising a first housing and a second housing, wherein the first housing and the second housing are respectively formed by stamping two metal pieces, two recessed portions are formed on opposite sides of the first housing and the second housing, respectively, the recessed portion of the first housing and the recessed portion of the second housing enclose an accommodating space, the tube body has at least two tube openings communicating with the accommodating space of a furniture tube.

2. The tube joint structure according to claim 1, wherein the tube body is an I-shaped structure, an arc-shaped structure, a T-shaped structure, a four-way tube structure, or a five-way tube structure.

3. The tube joint structure according to claim 2, wherein the tube openings face toward different directions.

4. The tube joint structure according to claim 1, wherein the opposite sides of the first housing and the second housing comprise two side surfaces, respectively; the side surface of the first housing and the side surface of the second housing are attached to each other, and the first housing and the second housing are fixed with each other by a fixing means.

5. The tube joint structure according to claim 1, wherein the opposite sides of the first housing and the second housing comprise two side surfaces, respectively; the side surface of the first housing and the second side surface of the second housing are parallel aligned and spaced apart from each other, a gap is between the side surface of the first housing and the side surface of the second housing; the recessed portion of the first housing and the recessed portion of the second housing are assembled on an outer periphery of the furniture tube component, and the first housing and the second housing are respectively fixed on the outer periphery of the furniture tube component by a fixing means.

6. The tube joint structure according to claim 1, wherein a protruding flange is formed on an outer periphery of each of the tube openings.
